(19) United States
(12) Patent Application Publication
(10) Pub. No.: US 2012/0321907 A1
(43) Pub. Date: Dec. 20, 2012

(54) BONDING PROCESS FOR SENSITIVE MICRO- AND NANO-SYSTEMS

(75) Inventors: Nils Hoivik, Horten (NO); Birger Stark, Horten (NO); Anders Elfing, Horten (NO); Kaiying Wang, Horten (NO)

(73) Assignee: SENSONOR TECHNOLOGIES AS, Horten (NO)

(21) Appl. No.: 13/582,131

(22) PCT Filed: Mar. 1, 2011
(86) PCT No.: PCT/EP11/53047

§ 371 Date: Aug. 31, 2012

(30) Foreign Application Priority Data
Mar. 2, 2010 (EP) 10155251.1

(51) Int. Cl. B23K 31/02; B23K 20/10; B32B 15/00; B23K 20/22

(52) U.S. Cl. 428/615; 228/101; 228/262.6; 228/110.1

(57) ABSTRACT

A metal inter-diffusion bonding method for forming hermetically sealed wafer-level packaging for MEMS devices. A stack of a first metal is provided on a surface of both a first wafer and a second wafer, the first metal being susceptible to oxidation in air; providing a layer of a second metal, having a melting point lower than that of the first metal, on an upper surface of each stack of the first metal, the layer of second metal being sufficiently thick to inhibit oxidation of the upper surface of the first metal; bringing the layer of the second metal on the first wafer into contact with the layer of second metal on the second wafer to form a bond interface; and applying a bonding pressure to the first and second wafers at a bonding temperature lower than the melting point of the second metal to initiate a bond, the bonding pressure being sufficient to deform the layers of the second metal at the bond interface.

The present invention relates to an inter-diffusion method for bonding micro and nano-structures, and in particular a method for 3D integration, as well as packaging, of sensitive and fragile structures or components typically performed at wafer level.

A challenge when developing sensitive structures, such as micro- and nano-electromechanical systems (MEMS) and MEMS-based devices, is that nearly all MEMS devices require a specially designed package to hermetically seal and, or, protect the sensitive and delicate components within. In particular, some classes of MEMS devices require very low vacuum levels in the package, whereas others classes require a specific pressure and, or, gas mixture to operate according to the specified design and intention.

U.S. Pat. No. 7,132,721 teaches a bonding process wherein a first material is deposited on a first wafer surface, a second material is deposited on a second wafer surface and the two wafer surfaces are pressed together to effect a bond, wherein inter-diffusion between the first and second materials forms an alloy compound which then holds the wafers together.

A problem with this and similar methods, however, is that depositing different materials on each wafer can increase irregularities and non-uniformities on the bonding surfaces of each wafer, thus affecting the quality of any resulting bond. Furthermore, if the deposited material is susceptible to oxidation in air, a native oxide can form on the bonding surfaces, which reduces wetting and acts as a barrier to prevent intermixing between the first and second materials when the bonding surfaces, either on the wafer and chip or on the wafer pairs, are brought into contact. Therefore, if oxide forms on a bonding surface, a pre-treatment is generally required to remove this layer before the materials can be bonded.

Pre-treatment typically involves a flux procedure that is, preferably, performed in-situ during assembling of the system, rather than ex-situ, to prevent oxidation, which since oxidation can occur very quickly. Some examples of chemicals commonly used in such procedures are hydrochloric acid, sulphuric acid, vapor formic acid, or forming gas. However, while these acids are effective oxide removers, they are also known to have a significant negative impact on sensitive micro- or nano-structures. In particular, any wet processing, which typically involves processing the wafers in a liquid acid or similar, as mentioned earlier, is not compatible with released and fragile micro- or nano-structures without further requiring additional cumbersome processing techniques.

In addition, most simple surface treatment procedures are most effective at temperatures near the melting point of the second material. Hence, after in-situ pre-treatments, such as the flux treatments described above, the first and second materials are typically brought into contact under pressure at already relatively high temperatures, which are then ramped-up to a temperature that exceeds the melting point of the second material. This can result in a large volume of the second material melting all at once, which can lead to undesired squeeze and flow of the second material to the surroundings, which can in turn cause electrical shortcuts or damage the micro- or nano-devices. Furthermore, there is also the risk that any unreacted second material at the end of the bonding process will re-melt during high temperature post-processes such as getter activation or lead-free soldering.

Consequently, it is generally difficult to perform any surface treatment to remove an oxide layer during any bonding process involving delicate structures such as MEMS components, thin film metal conductors or dielectrics, without potentially damaging those delicate structures.

Another well known inter-diffusion bonding method is solid liquid inter-diffusion (SLID) technology, which originates from chip-to-wafer processes for 3D micro-system integration. A typical implementation of this technology involves a chip with a first metal that may be susceptible to oxidization in air having a layer of a second metal provided on top, wherein the first metal has a higher melting point than the second metal. An example is Cu—Sn SLID bonding, wherein Cu is easily oxidized in air and has a much higher melting point than Sn.

Existing SLID bonding of chip-to-wafer processes, however, have a number of associated problems. As an example, where chips are individually attached to a wafer, the typical maximum bonding temperatures that are used, and at which temperature the wafer may be held at, exceed the melting point of the second metal. This prevents the presence of both the first and second metals on the wafer surface since diffusion of the first metal into the second metal would lead to a compound being formed extending all the way to the bonding surface, before all the dies are assembled, which is undesirable. Therefore, only the first metal is deposited on the wafer surface while both the first and metals are deposited on the chip surface.

An alternative chip-to-wafer bonding process, described in U.S. Pat. No. 6,872,464, is based on assembly at low-temperature followed by a high-temperature reflow process. However, this process involves a low-temperature pre-bond achieved using a soldering agent based on a therm-plastic polymer. Similarly, US 2006/0292824 teaches a method of die to wafer bonding wherein a polymeric adhesive layer is patterned around the die provided on a first wafer and this polymer cures during the bonding process to provide a permanent glue layer that secures the die-wafer bonding after a bonding pressure is released.

However, neither of these two methods is suitable for forming hermetically sealed MEMS packages because over time the polymer will deteriorate (out gassing) and molecules will disperse into the atmosphere within the sealed vacuum cavity of the package, thereby compromising the vacuum level.

An object of the present invention is to provide a bonding process for forming, at wafer-level, hermetically sealed packaging for encapsulating MEMS devices, in particular, chemically sensitive MEMS devices, such as microbolometers.

According to the present invention there is provided a metal inter-diffusion bonding method for forming hermetically sealed wafer-level packaging for MEMS devices, comprising the steps of: providing a stack of a first metal on a surface of both a first wafer and a second wafer, said first metal being susceptible to oxidation in air; providing a layer of a second metal, having a melting point lower than that of the first metal, on an upper surface of each stack of first metal, the layer of second metal being sufficiently thick to inhibit oxidation of the upper surface of the first metal; bringing the layer of second metal on the first wafer into contact with the layer of second metal on the second wafer to form a bond interface; and applying a bonding pressure to the first and second wafers at a bonding temperature lower than the melting point of the second metal to initiate a bond, the bonding pressure being sufficient to deform the layers of second metal at the bond interface.

The present invention therefore provides a bonding method that enables metal bonding between wafers for encapsulating devices having delicate or chemically sensitive components, which, for many applications, require hermetic sealing, with or without vacuum cavities. Using the method of the present invention, bonding and 3D integration can be performed at wafer-level on wafers that are unable to withstand flux procedures, or other surface pre-treatment, that are usually required to remove surface oxides or prevent oxidation of bonding surfaces. Therefore, delicate or chemically sensitive components or devices can be provided on both of the wafers to be bonded.

This is because the second metal, having a lower melting point than the first metal, acts as a protective layer for the first metal on both of the wafers to be bonded together to prevent oxidation of the first metal surface. This allows for longer storage periods of fabricated bonding partners than for samples with exposed first metal surfaces which are prone to oxidize.

More specifically, without a second metal acting as a protective layer, a native oxide would soon cover the first metal exposed surface, which has the negative effect of preventing wetting and inter-diffusion of the two metals during the bonding process, and therefore requires either removal by etching, or using a reduction process, which is potentially damaging to the delicate components.

Furthermore, because the bonding pressure is sufficient to deform the surfaces of the layers of second metal at the bond interface, this has the effect of removing any surface asperities on either layer to provide a very good, uniform bonding interface. Also, the wetting condition of the bonding surfaces is enhanced due to the bonding surfaces being of the same metal.

In addition, bringing the wafers into contact at relatively low temperature, compared to the melting point of the second metal, provides a more uniform temperature distribution throughout the wafer stack at an early stage of the process, since both wafers are in thermal contact with the temperature regulated bonding chucks.

A further advantage of the present invention is that most intermetallics are formed below the melting point of the second metal, which reduces the volume of liquid materials present during the bonding process when compared with existing SLID processes.

The present invention provides a flux-free bonding process, which is also free from any other surface pre-treatments such as pre-annealing or use of a soldering agent and is therefore compatible with delicate micro- and nano-scale electromechanical devices, thin film metal conductors or dielectric surfaces, in particular after they are released and left free-standing.

An example of the present invention will now be described with reference to the following figures, in which:

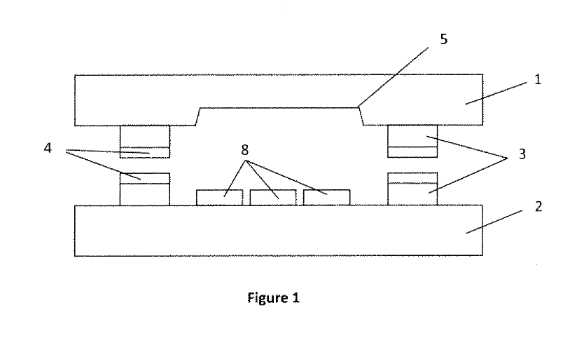

FIG. 1 shows two wafers, prepared according to the present invention, prior to bonding;

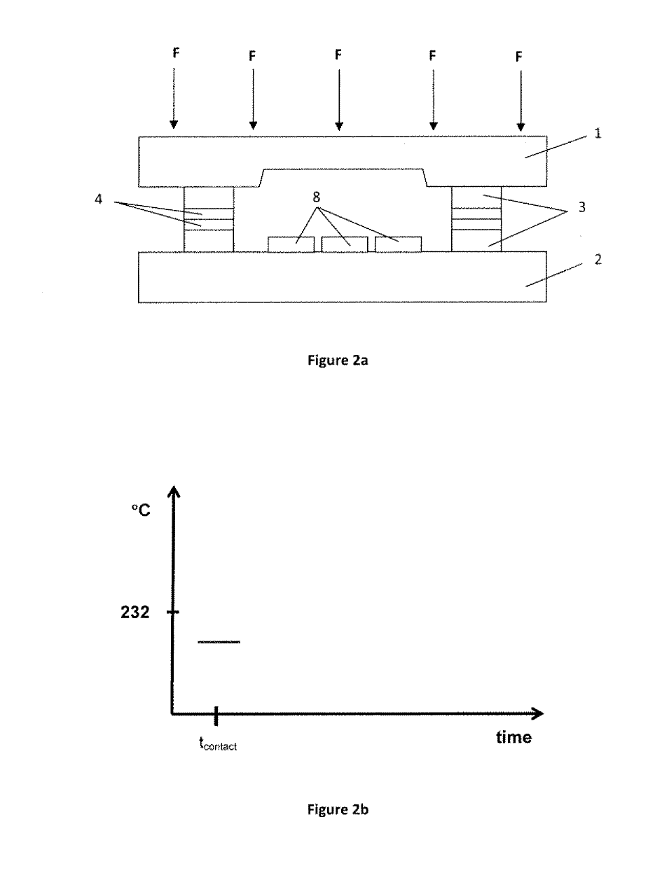

FIG. 2a shows the wafers of FIG. 1 as they are initially brought together;

FIG. 2b is a graph of time vs. temperature relating to the bonding process stage in FIG. 2a;

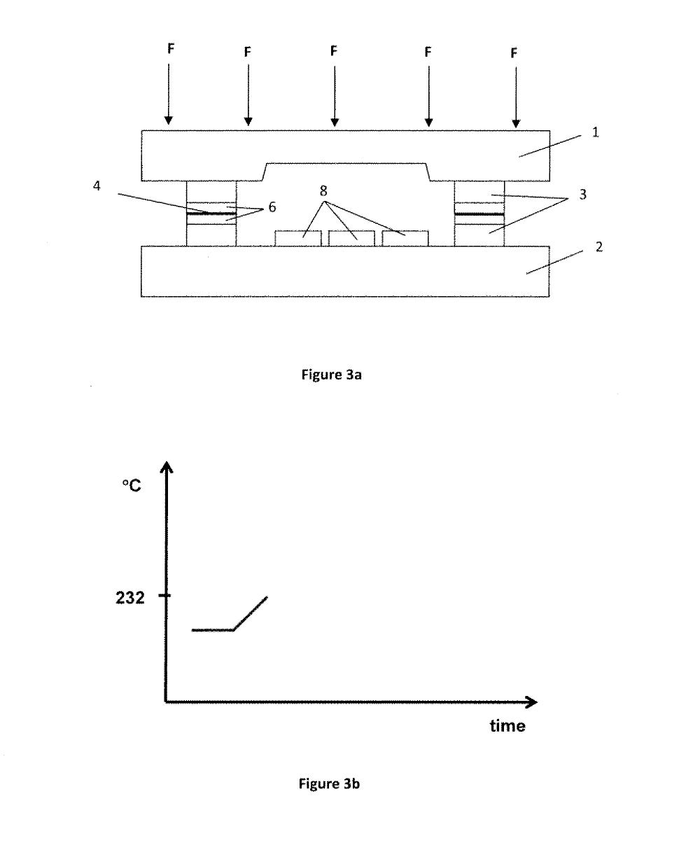

FIG. 3a shows an inter-diffusion bond region forming between two surfaces when the temperature is raised;

FIG. 3b is a graph of time vs. temperature relating to the bonding process stage in FIG. 3a;

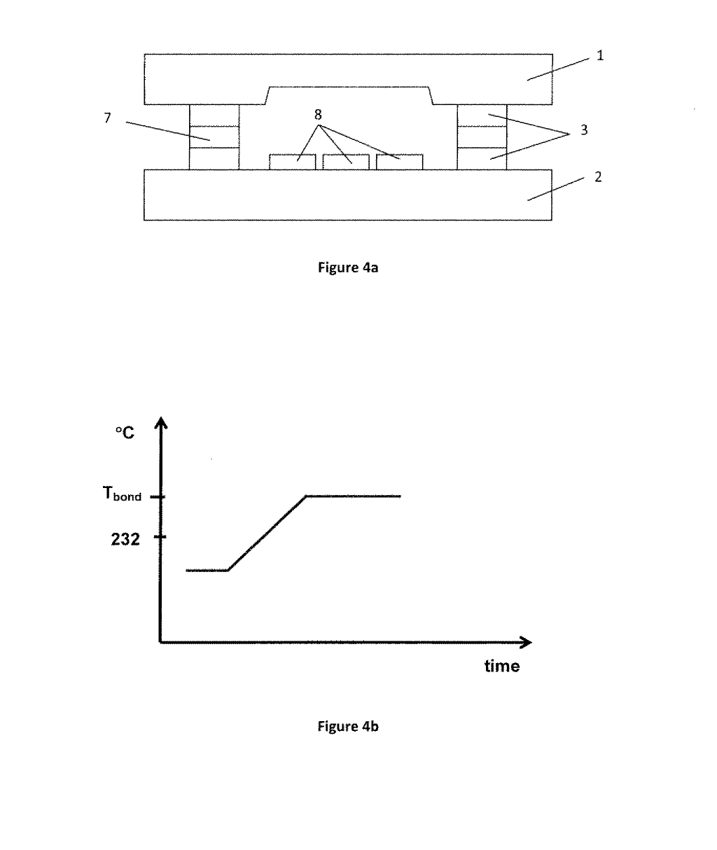

FIG. 4a shows the final compound formation after the bond is formed;

FIG. 4b is a graph of time vs. temperature relating to the bonding process stage in FIG. 4a;

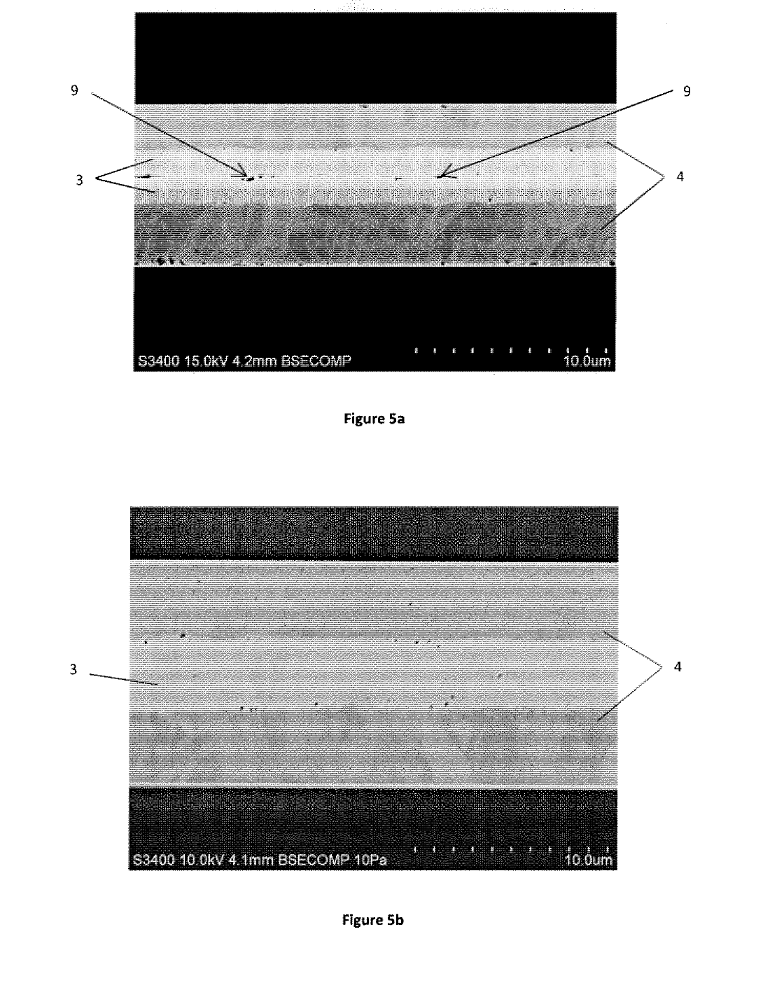

FIG. 5a shows a bonding interface between two wafers joined using the method of the present invention with an applied bonding pressure of about 10 MPa; and

FIG. 5b shows a bonding interface between two wafers joined using the method of the present invention with an applied bonding pressure of about 17 MPa.

Although in this example of the present invention, the first metal is Copper (Cu) and the second metal is Tin (Sn), it will be understood by a person skilled in the art that other combinations of suitable metals, wherein the metal with the higher melting point oxidizes in air to form a thick native oxide, such as, but not limited to, Silver (Ag) or Nickel (Ni), can be used. Furthermore, the examples herein discuss a silicon wafer or substrate, but it will be appreciated that the wafer or substrate may include other materials like, but not limited to, Ge, glass, quartz, SiC and/or Group III-V semiconductors.

A stack of Cu 3, with a thickness typically ranging between 1-10 μm, is patterned on a surface of a first wafer 1, in this example a Si wafer. A layer of Sn 4 is then deposited on top of the Cu stack 3, as shown in FIG. 1. The Sn layer 4 is sufficiently thick to prevent oxidation of the surface of the Cu stack 3 and while ensuring that an amount of un-reacted Sn will remain when the first wafer 1 is brought together with a corresponding second wafer 2, as discussed further on. In this example, the Sn layer 4 has a thickness greater than 0.5 μm and, for an inter-diffusion process to complete, the ratio of Cu to Sn must be greater than 1.3 in order to guarantee complete transformation to a resulting Cu₃Sn compound 7 in the solidified bond.

In addition to forming part of the final metal compound, the Sn protects the Cu from oxidation so that the wafers 1, 2 can be stored over long periods of time between deposition and assembling processes.

In this particular example, the Cu and Sn pattern deposited on the surface of the first wafer 1 defines a boundary around a recess 5 that has been formed in the surface. Getter material or other chemically sensitive material (not shown) may be provided in the recess 5 of the first wafer 1 and/or on the second wafer 2. Cu and Sn are also deposited on a second wafer 2 having a similar configuration with preferably, but not necessarily, identical thicknesses and lateral geometries as for the Cu stack 3 and Sn layer 4 deposited on the first wafer 1.

The second wafer 2 is shown having a number of delicate components 8 provided on it for illustrative purposes. Such delicate components 8 are often chemically sensitive and, of course, may be provided on either of the first wafer 1 and/or second wafer 2, depending on the intended purpose of the resulting structure.

Deposition can, for example, be performed using either electro-plating, or electroless-plating, starting from appropriate seed layers, or by any other means of deposition method, as well known in the art.

FIG. 2a shows the first and second wafers 1, 2 as they are initially brought into contact by application of a bonding force F on the first wafer 1 (assuming that the second wafer 2 is placed a solid surface) to initiate a bonding process. This initial step of the process is performed below the melting temperature of Sn, as illustrated on the “temperature vs. time” graph shown in FIG. 2b. Advantageously, this initial process step can be performed at relatively low temperatures when compared with existing SLID methods, even at room temperature, if necessary. However, the temperature at which the wafers are brought together will depend on the required properties of the resulting bonded structure, which are driven by its intended use, such as vacuum encapsulation or hermetic sealing, as will be understood by a person skilled in the art.

FIG. 3a shows the next step of the exemplary process wherein, as the first and second wafers 1, 2 are brought into contact, the Sn layers 4 are squeezed together under pressure created by the bonding force F and an intimate metallic contact is facilitated between the Sn—Sn interface. As can be seen from FIG. 3b, this step of the process also occurs at a temperature below the melting point of Sn, although it can be seen that the temperature starts to increase after initiation of bonding. The pressure created by the bonding force F leads to Sn deformation, breaking up any thin oxide layer that typically forms on Sn, and smoothing out surface asperity. This deformation can further be enhanced by the application of ultrasonic energy.

Heat accelerates inter-atomic diffusion and hence the Sn—Sn bond formation. Heat also accelerates the formation of inter-metallic compounds 6 at the Cu—Sn interfaces on each CU stack 3 so that only a small amount, if any, pure Sn layer 4 is left in between the Cu stacks 3 when the melting temperature of Sn, which is approximately 232° C., is exceeded, depending on temperature profile and metal thicknesses. The inter-metallics 6 consist of Cu₆Sn₅ at temperatures below 150° C., being gradually converted to Cu₃Sn at higher temperatures when excess Cu is present.

FIG. 4a shows the resulting structure at the end of the process with the first and second wafers 1, 2 bonded by a CuₓSn_{y} alloy compound 7. The composition of the CuₓSn_{y} alloy compound depends on the temperature at the Cu—Sn interface during the process, although it is preferably Cu₃Sn. As can be seen from the temperature profile shown in the graph of FIG. 4b, in this example, the bonding process is completed at a temperature exceeding the melting point of Sn. The temperature profile must be tuned to ensure that all of the Sn 4 is converted into the desired CuₓSn_{y} alloy compound.

In this example, a constant increase in temperature is shown as occurring throughout the process. However, the increase in temperature may not be constant, and may be varied both below and above the Sn melting point. This variability can have benefits in terms of controlling bonding. As mentioned above, however, with this process it is possible to achieve a good intermediate metallic Sn—Sn bond and at the same time reduce the residual volume of unreacted Sn left at the bonding interface with a proper temperature profile before reaching its melting point

Accordingly, the present invention could be regarded as a solid state process, wherein an inter-metallic compound 6 and/or resulting CuₓSn_{y} alloy compound 7 phases are formed without necessarily relying on liquidation of the pure Sn layer 4, since both Cu₆Sn₅ and Cu₃Sn phases have melting points higher than melting temperature of Sn and the maximum bonding temperature. Depending on how the process is set up, a liquid Sn phase may not exist at all, or can be limited to a very narrow region near the Sn—Sn interface.

The bonding force applied to the first and second wafers 1, 2 when being joined must be sufficiently high to allow the Sn layers 4, which form mating surfaces on both wafers 1, 2, to make intimate contact such that any non-uniformities across the wafer 1, 2 can be absorbed by the ductile Sn.

Having a Sn layer 4 on both mating surfaces can further improve the total Sn thickness uniformity compared to state of the art processes. It is also possible to compensate for non-uniformities on either of the wafers 1, 2 by using a modified layout on the other wafer 1, 2. This could, for example, include mirrored individual dummy structures on the two wafers 1, 2.

The bonding force applied to the wafers when assembled should be sufficiently high to provide a bonding pressure greater than 0.05 MPa and, preferably, in the range 5 MPa to 50 MPa, such that any non-uniformities across the bonding surfaces are absorbed by the ductile Sn. In practice, bonding pressures in the range 15 MPa to 25 MPa have been found to be suitable to reduce the effect of any surface asperities and lead to good and uniform bond lines.

FIG. 5a shows a cross-section of a package bonded at a temperature lower according to the present invention using a bonding pressure of around 10 MPa. It can be seen that, under this bonding pressure, the surfaces of Sn 3 have deformed to provide a good bond interface, although a small number of voids 9 are still visible. FIG. 5b shows a cross-section of a package bonded at 17 MPa, which is within the preferred pressure range of about 15 MPa to about 25 MPa. It can be seen in this example that the surfaces of Sn 3 have deformed sufficiently to provide a completely smooth bond interface, thereby eliminating any voids 9.

In the example above, the temperature profile has been selected such that significant interdiffusion of Cu and Sn occurs below the 232° C. melting point of Sn, as can be seen from FIGS. 3a and 3b. This approach facilitates having very little, if any, unreacted Sn remaining at the Sn—Sn interface when the melting point of Sn is reached. Accordingly, since very limited, if any, molten material is present during the bonding process, any uncontrolled out-flow of molten Sn is thereby efficiently minimized. FIGS. 4a and 4b show the resulting CuₓSn_{y} 7 bond formed above the melting point for Sn. As mentioned above, different intended applications of the resulting structure may require different CuₓSn_{y} compositions.

Advantageously, the structure does not need to be held above the melting temperature of Sn for a long time during its formation since a majority of the inter-diffusion process will have already occurred at lower temperatures.

Any thickness non-uniformities across the wafers 1, 2 will be absorbed by the ductile Sn during the process by exerting the large bonding force F on the wafers 1, 2 during temperature ramping.

In another example of the present invention, CuSn bonding structures can be used for 3D interconnects. Flux-less assembling on wafer level can be performed by deposition of a Cu stack and Sn layer configuration on both wafers, similar to that described above. The structures in this example are designed as individual contacts. In this further example, Sn flow can also be minimized by allowing for Cu—Sn/Sn—Cu interdiffusion below 232° C.

Both of the examples described above are suitable for high volume production using conventional wafer-level processes and, furthermore, can be combined together on the same wafer.

Advantageously, none of the bonding surfaces of the second metal having the lower melting point, e.g. Sn, need to be treated with flux prior to, or during, bonding. Furthermore, hermetic seals at wafer-level can be accomplished with a flux-less process and bonding parameters can be optimized to limit Sn flow when joining the wafers together by tuning the temperature profile and force when compared with existing methods, where flux is required.

Although the example given above is suitable for wafer-level bonding, a skilled person will appreciate that the same principles apply for chip-level bonding of sensitive and delicate components that would otherwise be damaged using a method requiring a pre-treatment to the bonding surfaces before bonding.

The present invention therefore provides a SLID-type bonding method suitable for bonding sensitive structures, which may contain fragile components, at wafer-level without any type of pre-treatment of the separated wafers being required.

1. A metal inter-diffusion bonding method for forming hermetically sealed wafer-level packaging for MEMS devices, comprising the steps of:
providing a stack of a first metal on a surface of both a first wafer and a second wafer, said first metal being susceptible to oxidation in air;
providing a layer of a second metal, having a melting point lower than that of the first metal, on an upper surface of each stack of first metal, the layer of second metal being sufficiently thick to inhibit oxidation of the upper surface of the first metal;
bringing the layer of second metal on the first wafer into contact with the layer of second metal on the second wafer to form a bond interface; and
applying a bonding pressure to the first and second wafers at a bonding temperature lower than the melting point of the second metal to initiate a bond, the bonding pressure being sufficient to deform the layers of second metal at the bond interface.

2. The method of claim 1, further comprising increasing the bonding temperature to the melting point of the second metal to form an inter-metallic compound which bonds the first and second wafers together.

3. The method of claim 2, wherein the first metal is Copper and the second metal is Tin.

4. The method of claim 3, wherein the bonding temperature is increased in a constant manner while the bonding force is applied.

5. The method of claim 3, wherein the bonding temperature is increased in a non-constant manner while the bonding force is applied.

6. The method of claim 3, wherein the bonding temperature does not exceed the melting point of the second metal while the bonding pressure is applied.

7. The method of claim 6, wherein the bonding pressure is greater than 0.05 Mpa.

8. The method of claim 7, wherein the bonding pressure is between 5 MPa and 50 Mpa.

9. The method of claim 7, wherein the bonding pressure is between 15 MPa and 25 MPa.

10. The method of claim 9, wherein one or more bonding parameters including force, temperature and sonic energy are controllable during the bonding process to alter the inter-diffusion achieved at the bond interface.

11. A hermetically sealed structure, comprising a first wafer and a second wafer that are bonded together by an inter-metallic compound formed using the method of claim 1, wherein the inter-metallic compound has an inter-metallic bond interface.

12. The hermetically sealed structure according to claim 11, wherein the structure contains a MEMS device, getter material or chemically sensitive material.

13. The hermetically sealed structure according to claim 12, wherein the MEMS device is chemically sensitive.

14. A plurality of hermetically sealed structures according to claim 11, wherein the plurality of structures is formed at wafer-level.

15. The method of claim 2, wherein the bonding temperature does not exceed the melting point of the second metal while the bonding pressure is applied.

16. The method of claim 15, wherein the bonding pressure is greater than 0.05 Mpa.

17. The method of claim 16, wherein the bonding pressure is between 5 MPa and 50 Mpa.

18. The method of claim 17, wherein the bonding pressure is between 15 MPa and 25 MPa.

19. The method of claim 18, wherein one or more bonding parameters including force, temperature and sonic energy are controllable during the bonding process to alter the inter-diffusion achieved at the bond interface.

20. The method of claim 1, wherein the first metal is Copper and the second metal is Tin.
